(19) United States
(12) Patent Application Publication
(10) Pub. No.: US 2018/0182329 A1
(43) Pub. Date: Jun. 28, 2018

(54) Data Independent Charge Sharing for Display Panel Systems

(71) Applicant: Parade Technologies, Ltd., Santa Clara, CA (US)

(72) Inventors: Quan Yu, Shanghai City (CN); CuiHua Jia, Nanjing City (CN); Ta-Tao Hsu, Zhubei City (TW); Yueh-Lin Yang, Zhubei City (TW); Haijun Chen, Shanghai City (CN); Kuo-Cheng Huang, Taipei City (TW)

(21) Appl. No.: 15/904,208

(22) Filed: Feb. 23, 2018

Related U.S. Application Data
(63) Continuation of application No. PCT/US16/48732, filed on Aug. 25, 2016.
(60) Provisional application No. 62/210,381, filed on Aug. 26, 2015.

(51) Int. Cl. G09G 3/36

(52) U.S. Cl. CPC G09G 3/3614; G09G 2330/021; G09G 3/3685

(57) ABSTRACT

A method including receiving information and a row of display data for display on a row of a display panel, sending the data to channels in accordance with the information, each channel supplying a portion of the row of display data to a column of pixels in the display panel using one a source driver, outputting, by a plurality of source drivers, the row of display data to the row of the display panel, and receiving a row completion indicator subsequent to the outputting. The method further includes determining, during a polarity period, a polarity state of a portion of the row of display data, identifying a group of source drivers, generating charge sharing enable signal(s) using the row completion indicator, and connecting outputs of source drivers in the identified group of source drivers together during the polarity period using the charge sharing enable signal(s).

### RELATED APPLICATIONS

This application is a continuation application of PCT Patent Application No. PCT/US16/48732, entitled “Data Independent Charge Sharing for Display Panel Systems” filed on Aug. 25, 2016, which claims priority to U.S. Provisional Patent Application 62/210,381, filed on Aug. 26, 2015, each of which is incorporated herein by reference in its entirety.

### TECHNICAL FIELD

The disclosure generally relates to reducing power consumption of source drivers for a display device.

### BACKGROUND

In many electronic devices, the display panel and associated drive circuitry consume a large portion of the dynamic power consumed by the electronic device. Conventional techniques to reduce dynamic power consumption for these devices include one or a combination of reducing the bias current applied to the drive circuitry, reducing the display supply voltage, or reducing the number of data lines that provide display information to the display. These conventional power reduction techniques, however, often negatively impact performance and may not be suitable for some display applications.

### SUMMARY

Various embodiments provide systems and methods of employing techniques to redistribute energy stored in the columns of a display panel. An example method includes receiving control information and a row of display data for display on a row of a display panel and sending the row display data to a plurality of channels in accordance with the control information, where each channel supplies a portion of the row of display data to one of a plurality of columns of pixels in the display panel using one of a plurality of source drivers. The method further includes outputting, by the plurality of source drivers, the row of display data to the row of the display panel, receiving a row completion indicator subsequent to the plurality of source drivers outputting the row of display data to the row of the display panel, and determining, during a polarity period, a polarity state of a portion of the row of display data sent to each of the plurality of source drivers. The method further includes identifying a group of source drivers, each source driver in the group outputting a portion of the row of display data with a same polarity state during the polarity period, generating one or more charge sharing enable signals using the row completion indicator, and connecting outputs of source drivers in the identified group of source drivers together during the polarity period using the one or more charge sharing enable signals.

In some embodiments, the row completion indicator is a horizontal blanking indicator.

In some embodiments, the polarity period corresponds to a time period during which a polarity inversion signal remains in the same polarity state. Further, in some embodiments, the method further includes connecting outputs of the source drivers in the identified group of source drivers together during the polarity period independent of the polarity inversion signal changing from a first state to a second state.

In some embodiments, connecting outputs of the source drivers in the identified group of source drivers together during the polarity period includes connecting outputs of source drivers coupled to even numbered channels together and separately.

Another example method may include receiving control information and a row of display data for display on a row of the display panel, sending the row of display data to a plurality of channels in accordance with the control information, each channel supplying a portion of the row of display data to one of a plurality of columns of pixels in the display panel using one of a plurality of source drivers, and outputting the row of display data to the row of the display panel. The method further includes determining, during a polarity period, a polarity state of the row of display data sent to one or more of the plurality of source drivers, generating one or more charge sharing enable signals subsequent to outputting the row of display data and during the polarity period, identifying a group of source drivers, each source driver in the group outputting row of display data with a same polarity state during the polarity period, and connecting outputs of source drivers in the identified group of source drivers together responsive to generating the charge sharing enable signal.

In some embodiments, the charge sharing enable signal is a horizontal blanking indicator.

In some embodiments, the polarity period is a time period during which a polarity inversion signal remains in the same polarity state. Further, in some embodiments, the method includes connecting outputs of the source drivers in the identified group of source drivers together during the polarity period independent of the polarity inversion signal changing from a first state to a second state.

In some embodiments, connecting outputs of the source drivers in the identified group of source drivers together during the polarity period responsive to generating the charge sharing enable signal includes connecting outputs of source drivers coupled to even numbered channels together and separately connecting outputs of source drivers coupled to odd numbered channels together within the identified group of source drivers.

In yet another instance, a display panel system is provided. The display panel system includes a video receiver configured to receive a video input signal and one or more control signals, the video input signal including display data organized into a plurality of rows and the control signals including a row completion signal. The display panel system further includes a display data analysis module configured to map a row of display data to a plurality of channels in accordance with the control signals, each channel supplying a portion of the row of display data to one of a plurality of columns of sub-pixels included in the display panel using one of a plurality of source drivers. The display panel system further includes a charge sharing controller configured to: (i) determine a polarity state of the portion row of display data sent to each of the plurality of source drivers during a polarity period, (ii) generate one or more charge sharing enable signals subsequent to the plurality of source drivers outputting the row of display data to the row of the display panel and during the polarity period, (iii) identify a group of source drivers from the plurality of source drivers, each source driver in the group outputting display data with a same polarity state during the polarity period, and (iv) connect outputs of source drivers in the identified group of source drivers together using the charge sharing enable signal.

### BRIEF DESCRIPTION OF DRAWINGS

The disclosed embodiments have other advantages and features which will be more readily apparent from the detailed description and the accompanying figures. A brief introduction of the figures is below.

FIG. 1 is a block diagram illustrating a display panel subsystem including a timing controller and source drivers, in accordance with some embodiments.

FIG. 2 is a detailed view of a source driver of the display subsystem, in accordance with some embodiments.

FIG. 3 is a detailed view of the timing controller of the display subsystem, in accordance with some embodiments.

FIG. 4 provides a detailed view of the display panel subsystem of FIG. 1, in accordance with some embodiments.

FIG. 5 provides a flowchart describing a process for implementing a charge sharing technique in accordance with some embodiments.

### DETAILED DESCRIPTION

The figures and the following description relate to embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable, similar or like reference numbers are used in the figures and indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview—Data Independent Charge Sharing

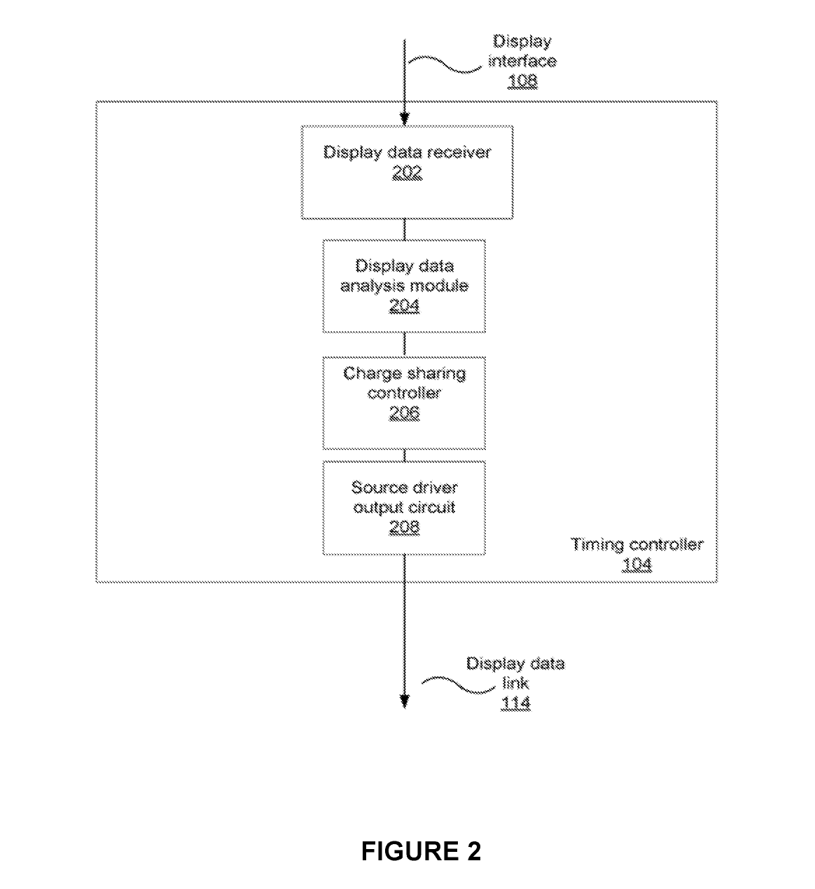

Various embodiments provide systems and methods for employing techniques to redistribute energy stored in the columns of a display panel. The disclosed display panel system employs charge sharing techniques during polarity state changes and during the same polarity period to reduce dynamic power dissipation in the display panel system. As discussed herein, polarity refers to the polarity of the analog voltage of the signal output by a source driver output and supplied to a display element of the display panel. The polarity state of the analog voltage signal output by the source driver output buffer is determined based on a polarity control signal generated by the timing controller 104 as discussed later regarding FIG. 2. A polarity period refers to the period during which the polarity control signal remains in the same polarity state.

The disclosed charge sharing methods and systems provide increased power savings by enabling charge sharing among a specified group of output channels after writing a row of display data and prior to writing a subsequent row of display data. An output channel refers to the transmission path formed by the output buffers of a source and the respective columns of pixels coupled to each output buffer. The output channels may be odd channels or even channels corresponding to the column number of the display panel. The outputs of each of the output buffers of odd numbered source drivers may be connected to an odd channel charge sharing line using a switch. Similarly, outputs of output buffers of even numbered source drives may be connected to an even charge sharing line using a switch. The timing controller uses a multiple charge sharing enable signals to selectively close switches to couple the outputs of certain groups of odd channels together and couple the outputs of certain groups of even channels together during a specified timing period.

The timing controller determines the polarity of the analog voltage signal supplied to each pixel within each row of display data and forms one or more groups of even output channels and one or more groups of odd output channels that have a common data polarity. To reduce dynamic power consumption during a polarity period, the timing controller generates a charge sharing enable signal when it determines that a row of display data has been written to a specified row of pixels in the display panel.

Activating the charge sharing enable signal causes switches to connect all of the outputs of the source drivers together within each group of output channels. Once connected, the closed switches between the selected set output channels allow energy to flow from columns at a higher voltage level to columns at lower voltage level within each group of output channels during the same polarity period. The switches remain closed until the end of a specified period (e.g., horizontal blanking period) is reached. Such a scheme reduces dynamic power consumption of the display panel system during the same polarity period, independent of a display data polarity transition.

### Display Panel Subsystem

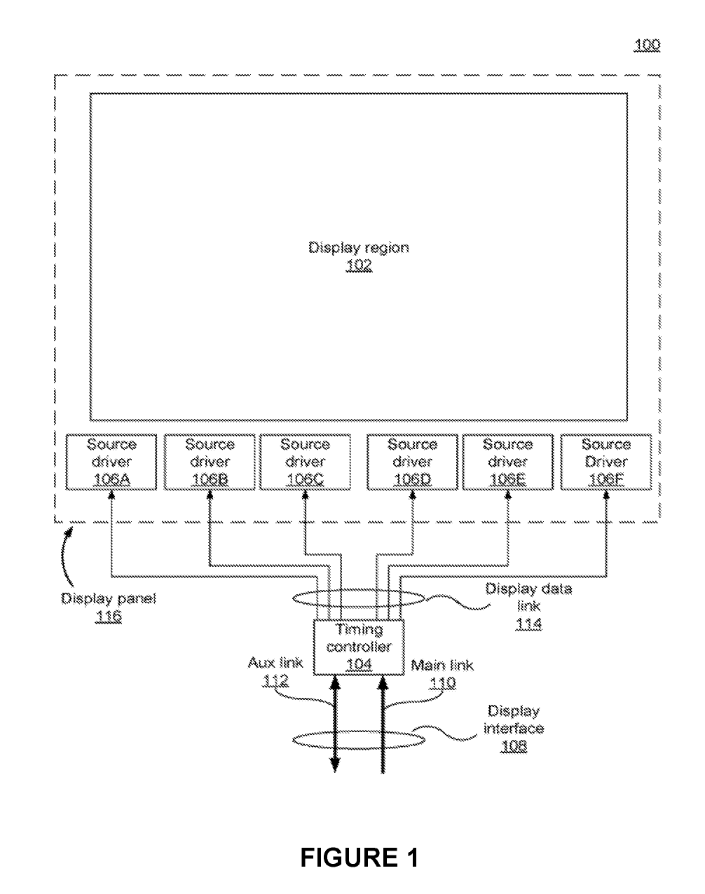

FIG. 1 illustrates a display panel subsystem 100 including a display panel 116, timing controller (TCON) 104, and source drivers 106. In the embodiment shown in FIG. 1, the display panel 116 includes one or more display regions 102 and multiple source drivers 106A, 106B, 106C, 106D, 106E, and 106F. The display region 102 includes an array of pixels arranged in multiple column and rows lines. In the embodiment shown in FIG. 1, the display region 102 is embodied as a liquid crystal display (LCD), such as a thin film transistor (TFT) LCD. The display region 102 uses a TFT or other active device type to control the operation of each pixel in accordance with display data and control information received from the timing controller 104. A pixel comprises sub-pixels associated with a different color (e.g., red, green, or blue). Each sub pixel includes a storage element, such as a capacitor, to store energy delivered by the voltage signals generated by a source driver 106. Energy stored in the storage device produces a voltage used to regulate the operation of the corresponding active device for each sub-pixel. The intersection of each row and column line provides an addressable location to control to operation of a sub-pixel placed at the intersection based on control information received from the timing controller 104.

The timing controller 104 receives display data from a source over display interface 108 and generates control and data signals to selectively apply display data included in the display data to certain sub-pixels included in the display region 102. Example display data sources include integrated circuits, such as a graphics processor unit (GPU), located within the same system that includes the display panel subsystem 100. Additional example display data sources include external computing system, such as a set-top box, digital video disk player, or other computing device that generates display data.

The display interface 108 is a video interface that couples the output of the display data source to the input of the timing controller 104. The display interface 108 may include an interface that conforms to specified physical, signaling, and protocol parameters suitable to transmit video data to the timing controller 104. In one implementation, the display interface 108 conforms to the DisplayPort family of video interface standards. In the embodiment shown in FIG. 1, the display interface 108 is a DisplayPort video interface that includes a main link 110 and an auxiliary link 112. The main link 110 is comprised of one or more differential signal lanes that carry video and/or audio data from the source to the timing controller 104. The auxiliary link 112 is a bi-directional differential signal channel that exchanges channel management information between the source and the timing controller 104. Example channel management information includes training information, and test and debug information, and channel or device status information. The display interface 108 shown in FIG. 1 may also conform to other versions of the DisplayPort video interface standard, such as Embedded DisplayPort, or other video interface standards.

The timing controller 104 processes the display data received from the source and generates display panel interface signals for driving the source drivers 106 included in the display panel 116, as further described in FIG. 2. The timing controller 104 receives display and control data from the display interface 108 and generates control and data signals to cause the display data to be displayed on the display panel 116. In one implementation, the timing controller 104 stores the received display data in an image buffer. The image buffer comprises a memory configured to store display data. To individually address each display segment, the timing controller 104 applies control and data signals to a specified row driver and source driver 106 to enable or disable the pixel located at the intersection of the specified row and column. In one implementation, each display element within a column of pixels included in the display panel 116 is connected to a source driver 106 via one or more data bus lines. The magnitude of the voltage of the display data signal carried by the one or more data bus lines determines the amount of light transmission supplied by each corresponding display element located in the display panel 116. The timing controller 104 interfaces with the display panel 116 using a display data link 114. The display data link 114 includes multiple point-to-point interconnects that couple the output of the timing controller 104 to each source driver 106. In the embodiment shown in FIG. 1, the display data link 114 is a point-to-point intra panel interface that conforms to the Scalable Intra Panel Interface (SIPI) standard.

The source driver 106 receives multi-bit digital display data from the timing controller 104 via a signal line included in the display data link 114, converts the display data to analog voltage signals, and sends the analog voltage signals to a specified column of sub-pixels using the column line. The number of data bits used to represent a display data value determines the number of light levels that a particular sub-pixel may produce. For example, 10-bit display data may be converted into 1024 analog signal levels generated by the output buffers included a source driver 106. A measure of the intensity of the light emitted by each sub-pixel may be represented as a gray level. In one implementation, the gray level is represented by a multi-bit value ranging from 0, corresponding to black, to a maximum value. In one example, a gray level is a 10-bit value representing one of 1024 values, with a maximum value of 1023.

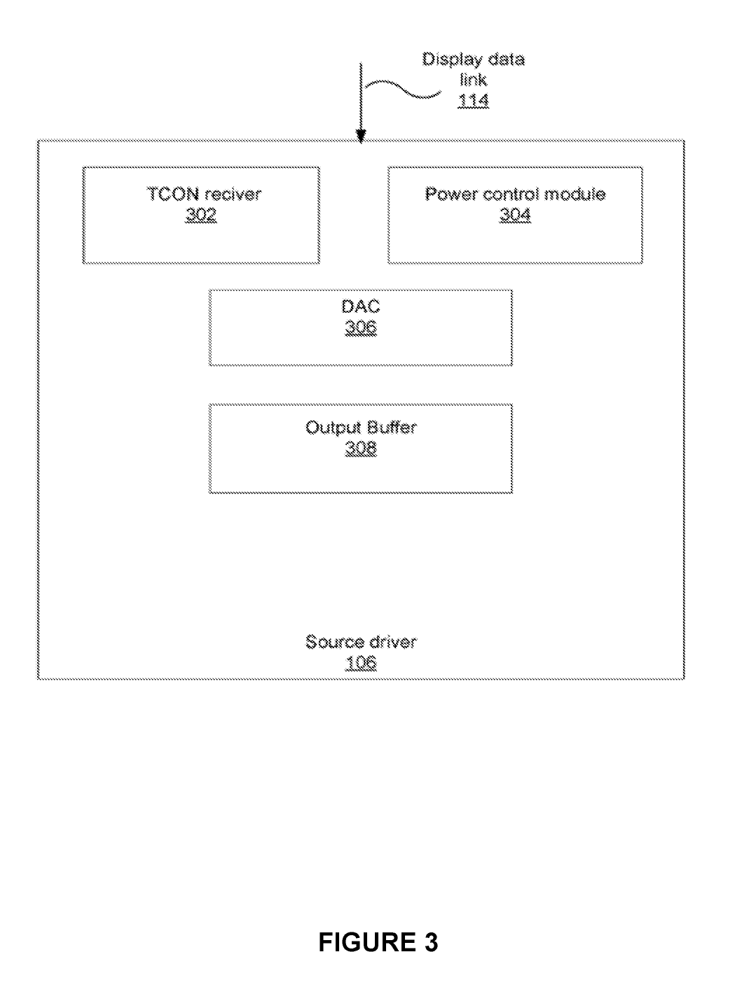

The transmission path including the output of each source driver 106 to the input of each sub-pixel in a specific column of sub-pixels is referred to herein as an output channel. A source driver 106 includes multiple output buffers, where each output buffer operates to rapidly charge the column line of the corresponding channel. In operation, the DC power supplied to each output buffer and the dynamic power expended to charge and discharge these highly capacitive output channels dominate the overall power consumption of the display panel subsystem 100. Further description of the output buffers is provided with reference to FIG. 3.

### Timing Controller Architecture

FIG. 2 illustrates a block diagram describing the architecture of the timing controller 104 in greater detail. In the embodiment shown in FIG. 2, the timing controller 104 includes a display data receiver 202, a display data analyzer 204, a charge sharing controller 206, and a source driver output circuit 208. The display data receiver 202 receives display data over the display interface 108 and generates control and data signals for displaying the display data in a display region 102 of the display panel 116. The display data includes display data, representing the image to be displayed in the display region 102, and control data that determines how the display data is presented in the display region 102.

The control data signals include global timing signals, such as vertical timing signals and horizontal timing signals. Vertical timing signals include vertical sync (VSYNC) or frame pulse (FP), and horizontal timing signals include horizontal sync (HSYNC) or line pulse (LP). The global timing signals also include display refresh signals for refreshing a displayed image, clock signals for operating row drivers, and clock signals and latch enable for operating source drivers 106. Using the global timing signals, the display data receiver 202 generates control signals to map display data to a specific group of sub-pixels in the display region 102. In particular, the display data receiver 202 uses the global timing signals to send signals to row drivers and source drivers 106 to drive display data onto a specified group of sub-pixels in the display region 102. The display data receiver 202 also uses the received global timing signals to generate control signals to refresh a frame of display data.

The display data receiver 202 is also configured to perform signal conditioning on the received data to adjust or modify one or more attributes of the received data for processing by other components of the timing controller 104. For example, the display data receiver 202 extracts timing information associated from display data or control data to use in conjunction with control circuitry (e.g., shift registers, input registers, data latches, etc.) to condition display data for output by the source drivers 106. Alternatively or additionally, the display data receiver 202 descrambles the received data, decrypts encrypted data, or adjusts the voltage, timing, or other characteristics of the received data for further processing by the display data analyzer 204 or charge sharing controller 206.

The display data analyzer 204 identifies attributes of the display data received by the display data receiver 202, and generates one or more data and control signals for displaying the received display data on the display region 102. Attributes of the received display data include data structure (e.g., a row of display data or a frame of display data) and signal type (e.g., display data, control data, or link status data). The display data analyzer 204 also derives other attributes of the received display data from signals provided by the display data receiver 202. For example, in one implementation, the display data analyzer 204 uses global timing and display data signals received over the display interface 108 to calculate a frame rate and a refresh rate for the incoming display data. The frame rate represents how often a display data source can feed an entire frame of new data to a display (e.g., display panel 116). The refresh rate represents the number of times per second in which the display panel 116 presents the display data provided by the source drivers 106.

The display data analyzer 204 also determines or derives additional control information using data received over display interface 108. Example additional control information includes mapping information describing the mapping of row data and column data to specified row drivers and source drivers 106, and polarity configuration information specifying the polarity state and a polarity inversion operation mode of the display data signals output by the source driver 106. The polarity inversion operation modes include, frame polarity inversion, row polarity inversion, or column polarity inversion operation mode. Using the configuration information, the display data analyzer 204 generates one or more polarity control signals for setting the polarity of display data signals output by the source drivers 106 in accordance with a specified polarity inversion operation mode.

To prevent permanent damage to the display elements within the display panel 116, the timing controller 104 alternates or inverts the polarity of display data signals supplied to each the display segment between successive sequential video frames. During a polarity inversion period, the timing controller 104 supplies a polarity inversion signal to each source driver 106 in accordance with a specified polarity inversion operation mode. Responsive to the polarity inversion signal, each source driver 106 outputs display data signals with alternate positive and negative polarity between the display elements with respect to a backside electrode in accordance with the specified inversion operation mode.

The timing controller 104 is configured to implement any one or a combination of different inversion operation modes. For example, in frame inversion operation mode, all display elements in the display panel are driven with the same polarity display data signal during even numbered (even) frames and the opposite polarity display data signal during odd numbered (odd) frames. In column inversion operation mode, display elements in adjacent columns are driven with opposite polarity display data signals and change polarity for each sequentially successive frames. Similarly, in row inversion operation mode, display elements in adjacent rows are driven with opposite polarity display data signals and change polarity for each sequentially successive frame. Dot inversion operation mode employs a combination of the column and row inversion that causes a display element-by-display element or display unit (e.g., pixel-by-pixel) inversion. In dot inversion operation mode, the display data signals applied to each display element or display unit pixel's voltage change polarity according to the one of neighbor pixel's polarity. Rather than employing charge sharing only responsive to an indication of a change of state of the polarity of the display data, the timing controller 104 invokes charge sharing during the same polarity period for specified groups of output channels of the display panel 116. Accordingly, the disclosed display panel subsystem 100 reduces dynamic power consumed by source drivers 106 independent of the occurrence of a polarity state transition of the display data supplied to the source drivers 106.

The additional control information also includes charge sharing configuration information specifying how the display panel subsystem 100 employs charge sharing among the source drivers 106. In one implementation, the charge sharing configuration includes information describing one or more groupings of output channels for applying charge sharing and one or more conditions for enabling charge sharing. The grouping information may specify one or more regions of the display panel 116 for applying charge sharing. In one embodiment, a region includes a specified number of output channels having a specified polarity state. In one example, the configuration information specifies grouping an even number of output channels with a positive polarity state into a group, and grouping an even number of output channels with a negative polarity state into another group. Other groupings may be specified to satisfy the needs of the particular system environment in which the display panel subsystem 100 operates.

The charge sharing configuration information specifies conditions for enabling charge sharing including the state of one or more control signals received or generated by the display data receiver 202. For example, in one implementation, the conditions for enabling charge sharing specify the logic state of a row completion signal (e.g., a horizontal blanking signal) being in an active state. In other implementations, conditions for enabling charge sharing specify one or a combination of voltage levels, logic state, or other attributes of global timing signals, control signal derived from the global timing signals, or data signals received via display interface 108 that form the basis for generating a charge sharing enable signal.

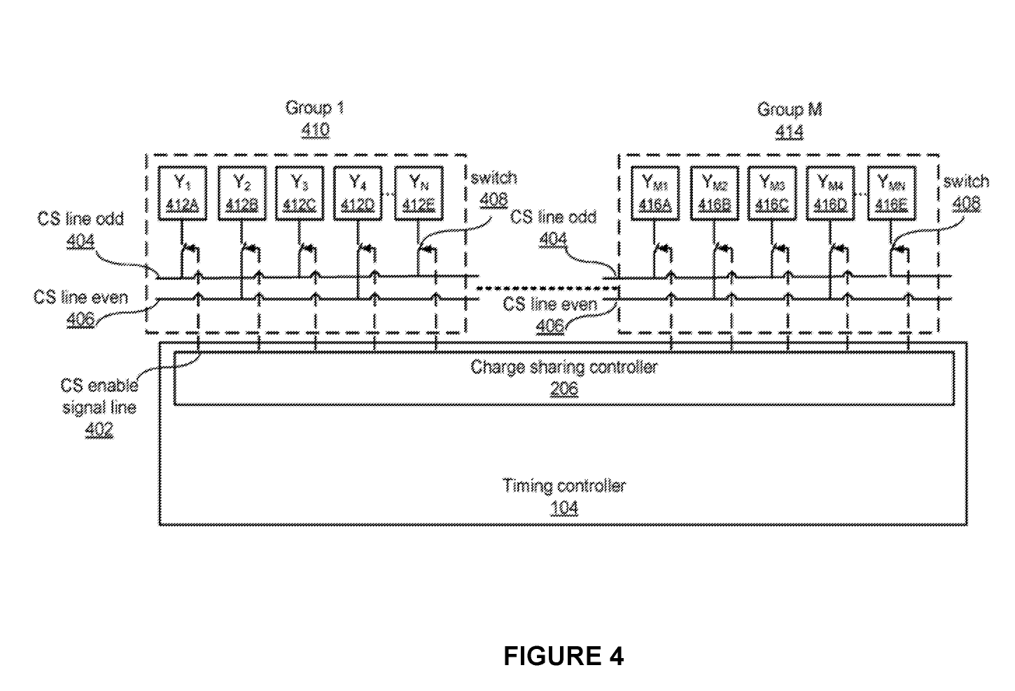

The charge sharing controller 206 enables charge sharing among the source drivers 106 of one or more groups of channels responsive to conditions specified in the charge sharing configuration information. The charge sharing controller 206 obtains charge sharing configuration information from the display data analyzer 204, and generates one or more charge sharing enable signals to connect the outputs of output channels together within a group of output channels. As previously described, the charge sharing configuration information specifies groupings of output channels and also specifies a set of conditions, which, if satisfied, cause the charge sharing controller 206 to generate one or more charge sharing enable control signals. During charge sharing operation mode, the charge sharing controller 206 generates one or more charge sharing enable signals to control the operation of switches coupled between the outputs the source drivers 106. The switches, as further described in reference to FIG. 4, operate to short the outputs of the source drivers 106 together within a specified group, responsive to receiving the charge sharing enable signal. The charge sharing enable signal is generated based on charge sharing configuration information specifying the control signal as previously described with reference to the display data analyzer 204. Responsive to receiving the charge sharing enable signal, the source driver output circuit 208 generates one or more source driver output disable signals to disable the outputs of the corresponding source drivers 106.

The source driver output circuit 208 transmits to each source driver 106 a portion of the display data received from the display interface 108 in accordance with the mapping information received by the display data receiver 202. In operation, the source driver output circuit 208 sends, on a row-by-row basis, a portion of the row of display data to each corresponding source driver 106 based on the mapping information. The source driver output circuit 208 also generates one or more control signals to synchronize when each portion of a row of display data is written to each corresponding source driver 106. The source driver output circuit 208 generates one or more additional control signals (e.g., source driver enable) to synchronize when each portion of a row of display data is output by each corresponding source driver 106 output buffer for display on the display panel 116.

To regulate the power consumption of the source drivers 106, the source driver output circuit 208 generates one or more source driver output disable signals. In one implementation, the source driver output circuit 208 generates separate source driver output disable signals to individually disable the output amplifiers coupled to each corresponding output channel. Responsive to the assertion of the source driver output disable signal, the output amplifier within a specified source driver 106 enters a high impedance state. While under a high impedance state, the output amplifier consumes substantially no power. Because the output amplifier consumes the largest portion of power consumed by the source driver 106, when the output amplifiers operate in a high impedance mode the source driver 106 consume substantially no power.

In one implementation, the source driver output circuit 208 generates a source driver output disable signal when the display panel subsystem 100 enters a lower power state. In one example, the source driver output circuit 208 asserts a source driver output disable signal to disable a specified number of source drivers 106 during a vertical blanking period, or during a period of time between frames of display data. The vertical banking period represents time difference between when the last row of one frame is output to the display panel 116, and the beginning of the first row of the next frame. Before the vertical blanking period ends, the source driver output circuit 208 de-asserts a source driver output disable signal. Thus, power consumption is reduced while the source driver 106 is disabled. This process is repeated during one or more subsequent vertical blanking period. The source driver output circuit 208 also operates in conjunction with the charge sharing controller 206 to generate one or more source driver output disable signals to disable the outputs of the corresponding source drivers 106 during charge sharing mode.

FIG. 3 illustrates a detailed view of a source driver 106 in accordance with one embodiment. The source driver 106 includes a TCON receiver 302, a power control module 304, a digital-to-analog converter (DAC) 306, and a source driver output buffer 308. The TCON receiver 302 is configured to receive video data from the source driver output circuit 208 included in the timing controller 104. The power control module 304 controls the power state of a source driver 106 based on instructions received from the timing controller 104. For example, during a vertical blanking period of the video input signal, the timing controller 104 may disable the source driver 106. Disabled, the source driver 106 enters a low power operation mode and ceases to drive the associated display elements coupled to the source driver output buffer 308. The source driver 106 may receive a source driver enable signal from the timing controller 104 and resume a normal operation mode and drive analog voltage signals representing display data to the display panel 116.

The DAC 306 processes digital information received by the timing controller receiver 302 and converts the digital information to analog signals that will be output by the source driver 106 to drive the display panel 116. The source driver output buffer 308 receives the analog voltage signals from the DAC 306 and buffers and/or amplifies the output of the DAC 306 for operating the active devices associated with display elements within the associated column of the display panel 116.

FIG. 4 illustrates a detailed view of the display panel subsystem 100 in accordance with one embodiment. The charge sharing controller 206, included in the timing controller 104, is coupled to switches 408 using charge sharing enable signal lines 402. The charge sharing controller 206 controls the operation of each switch 408 by sending a charge sharing enable signal over the individual charge sharing enable signal lines 402. The embodiment shown in FIG. 4 includes two groups of channels, group 1 410 and group M 414, where one group includes channels having a positive polarity state and the other group includes channels having a negative polarity state. For example, group 1 410 includes positive polarity channels Y₁ 412A, Y₂ 412B, Y₃ 412C, Y₄ 412D, through Y_{N} 412E, and group M 414 includes negative polarity channels Y_{M1} 416A, Y_{M2} 416B, Y_{M3} 416C, Y_{M4} 416D, through Y_{MN} 416E. Other implementations may include greater than or less than two groups of channels. Within each group of channels, the output of each odd numbered channel is coupled to an odd charge sharing signal line 404 using a switch 408. The output of each even numbered channel is coupled to an even charge sharing signal line 406 using a switch 408. Thus, during charge sharing mode, the timing controller 104 can connect the outputs of even channels together and odd channels together within a group of channels. Once connected, the outputs of the even channels within a group are shorted together to cause energy stored in the columns connected to the even channel within the group of channels to be redistributed (i.e., shared). Similarly, once connected, the outputs of the odd channels within a group are shorted together to cause energy stored in the columns connected to the odd channel within the group of channels to be redistributed.

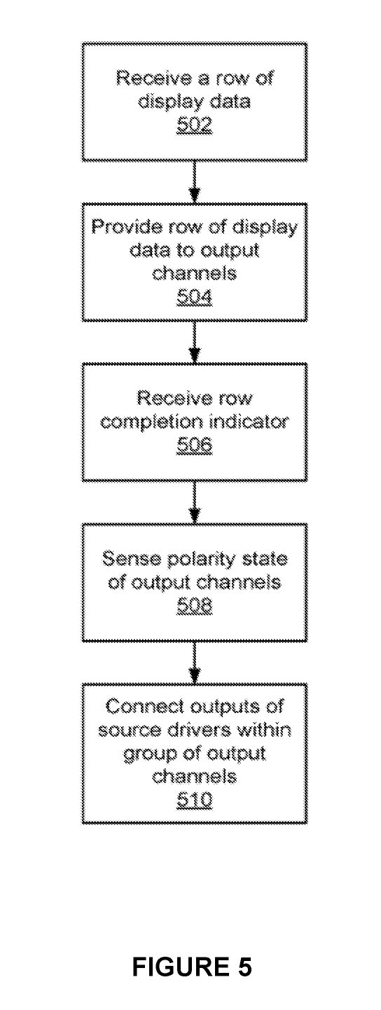

FIG. 5 illustrates a flow chart implementing the charge sharing technique in accordance with one embodiment. The timing controller 104 receives 502 a video input signal and one or more control signals from a source. In one embodiment, the video data includes a frame of display data organized into multiple rows. In one implementation, the one or more control signals includes a row completion signal, such as a horizontal blanking signal or any other signals from which the timing controller 104 can determine when a row of display data has been output by the source drivers for a group of output channels. The timing controller 104 provides 504 a row of display data to output channels in accordance with data mapping information received from the source. The mapping information may be derived from one or more control signals received by the display data receiver 302.

The timing controller 104 receives 506 a row completion indicator from the source of the display data. The row completion indicator is a control signal or is derived from control signals provided by the source of the display data to indicate the end (e.g., the last portion of data) of a row of display data. In one implementation, the row completion indicator is a horizontal blanking signal received from the source of the display data. The timing controller 104 determines 508 the polarity state of the display data output by the source drivers 106 based on information obtained from the timing controller 104. For example, in one implementation, the polarity state of the display data is determined by the state of the polarity signal supplied to the DAC 306 of a particular source driver 106.

Using the polarity state information, the charge sharing controller 206 identifies groups of output channels for invoking charge sharing. For example, groups of output channels may include groups of a specified number of channels of either a positive or a negative polarity. The charge sharing controller 206 is configured to invoke charge sharing on a channel group-by-channel group basis by connecting 510 outputs of the source drivers 106 of the respective output channels within a group of channels.

During charge sharing, the charge sharing controller 206 activates the charge sharing enable signals that causes switches coupled between the outputs of channels within a group to connect all of the outputs of the source drivers 106 together within each group of output channels. For example, for each source driver 106 having the same sensed polarity state during the polarity period, the charge sharing controller 206 generates one or more charge sharing enable signals to connect the output of a source driver 106 to the output of one or more additional source drivers 106 that belong to a group of source drivers 106 having the same sensed polarity state during the polarity period. The connections are formed using switches 408, coupled between the outputs of the source drivers 106, that close responsive to receiving a charge sharing enable signal. Once closed, the switches 408 between the selected output channels allow energy to flow from columns at a higher voltage level to columns at lower voltage level within each group of output channels. The switches 408 remain closed until the end of a specified period is reached. In one implementation, during charge sharing, the timing controller 104 also disables the output buffers of the source drivers 106 associated with a group of output channels to place the output of the source drivers 106 in a high impedance state. Such a charge sharing scheme reduces dynamic power consumed by the source drivers 106 within a polarity period independent of a polarity state transition event.

### Additional Considerations

The disclosed system and method beneficially reduce dynamic power consumption of source drivers in a display system. The outputs of source drivers within a group of source drivers in a display system are connected together responsive to the occurrence of a row completion signal to invoke charge sharing among the associated display panel columns during the same display data polarity period. The row completion signal operates as a charge sharing enable signal that when enabled closes the switches coupled between the outputs of the source drivers, which causes current to flow from columns at a higher voltage level to columns at lower voltage level. Charge is redistributed between the selected columns until the initial display data voltage level of each of the selected columns changes from an initial value to an average voltage value. Accordingly, when outputting a subsequent row of display data the selected columns may now be driven halfway, rather than the entire voltage range, to their final value. Such a technique reduces the dynamic power substantially during a polarity period because the row completion signal is used as the basis to generate a charge sharing enable signal.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion embodied as executable instructions or code) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The phrase “in one embodiment” in various places in the specification is not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and method for performing charge sharing during a polarity period through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope described.

What is claimed is:

1. A method, comprising:
receiving control information and a row of display data for display on a row of a display panel;
sending the row display data to a plurality of channels in accordance with the control information, each channel supplying a portion of the row of display data to one of a plurality of columns of pixels in the display panel using one of a plurality of source drivers;
outputting, by the plurality of source drivers, the row of display data to the row of the display panel;
receiving a row completion indicator subsequent to the plurality of source drivers outputting the row of display data to the row of the display panel;
determining, during a polarity period, a polarity state of a portion of the row of display data sent to each of the plurality of source drivers;
identifying a group of source drivers, each source driver in the group outputting a portion of the row of display data with a same polarity state during the polarity period;
generating one or more charge sharing enable signals using the row completion indicator; and
connecting outputs of source drivers in the identified group of source drivers together during the polarity period using the one or more charge sharing enable signals.

2. The method of claim 1, wherein the row completion indicator is a horizontal blanking indicator.

3. The method of claim 1, wherein the polarity period corresponds to a time period during which a polarity inversion signal remains in the same polarity state.

4. The method of claim 3, further comprising connecting outputs of the source drivers in the identified group of source drivers together during the polarity period independent of the polarity inversion signal changing from a first state to a second state.

5. The method of claim 1, wherein connecting outputs of the source drivers in the identified group of source drivers together during the polarity period comprises connecting outputs of source drivers coupled to even numbered channels together and separately connecting outputs of source drivers coupled to odd numbered channels together within the identified group of source drivers.

6. A method, comprising:
receiving control information and a row of display data for display on a row of the display panel;
sending the row of display data to a plurality of channels in accordance with the control information, each channel supplying a portion of the row of display data to one of a plurality of columns of pixels in the display panel using one of a plurality of source drivers;
outputting the row of display data to the row of the display panel;
determining, during a polarity period, a polarity state of the row of display data sent to one or more of the plurality of source drivers;
generating one or more charge sharing enable signals subsequent to outputting the row of display data and during the polarity period;
identifying a group of source drivers, each source driver in the group outputting row of display data with a same polarity state during the polarity period; and
connecting outputs of source drivers in the identified group of source drivers together responsive to generating the charge sharing enable signal.

7. The method of claim 6, wherein the charge sharing enable signal is a horizontal blanking indicator.

8. The method of claim 6, wherein the polarity period is a time period during which a polarity inversion signal remains in the same polarity state.

9. The method of claim 8, further comprising connecting outputs of the source drivers in the identified group of source drivers together during the polarity period independent of the polarity inversion signal changing from a first state to a second state.

10. The method of claim 8, wherein connecting outputs of the source drivers in the identified group of source drivers together during the polarity period responsive to generating the charge sharing enable signal comprises connecting outputs of source drivers coupled to even numbered channels together and separately connecting outputs of source drivers coupled to odd numbered channels together within the identified group of source drivers.

11. A display panel system comprising:
a video receiver configured to receive a video input signal and one or more control signals, the video input signal comprising display data organized into a plurality of rows and the control signals comprising a row completion signal;
a display data analysis module configured to map a row of display data to a plurality of channels in accordance with the control signals, each channel supplying a portion of the row of display data to one of a plurality of columns of sub-pixels included in the display panel using one of a plurality of source drivers; and
a charge sharing controller configured to:
determine a polarity state of the portion row of display data sent to each of the plurality of source drivers during a polarity period;
generate one or more charge sharing enable signals subsequent to the plurality of source drivers outputting the row of display data to the row of the display panel and during the polarity period;
identify a group of source drivers from the plurality of source drivers, each source driver in the group outputting display data with a same polarity state during the polarity period; and
connect outputs of source drivers in the identified group of source drivers together using the charge sharing enable signal.

12. The display panel system of claim 11, wherein the charge sharing enable signal is generated using a row completion signal.

13. The display panel system of claim 12, wherein the row completion signal is a horizontal blanking signal.

14. The display panel system of claim 11, wherein the charge sharing module is configured to connect outputs of source drivers coupled to even numbered channels together and separately connect outputs of source drivers coupled to odd numbered channels together within the identified group of source drivers.

15. The display panel system of claim 11, wherein the polarity period represents a time period during which a polarity inversion signal remains in the same polarity state.

16. The display panel system of claim 15, wherein the charge sharing module is configured to connect outputs of the source drivers in the identified group of source drivers together during the polarity period independent of the polarity inversion signal changing from a first state to a second state.

17. The display panel system of claim 11, wherein the charge sharing module is configured to disconnect outputs of the source drivers in the identified group of source drivers subsequent to an end of a horizontal blanking interval.
